(19) United States
(12) Patent Application Publication
(10) Pub. No.: US 2026/0269295 A1
(43) Pub. Date: Sep. 10, 2026

(54) INTEGRATED MEMBRANES WITH ENGINEERED FUNCTIONAL LAYERS FOR FUEL CELLS AND ELECTROLYZERS

(71) Applicant: GM Global Technology Operations LLC, Detroit, MI (US)

(72) Inventors: Ruichun Jiang, Troy, MI (US); Swaminatha P. Kumaraguru, Rochester Hills, MI (US); Craig S. Gittleman, West Bloomfield, MI (US)

(21) Appl. No.: 19/069,406

(22) Filed: Mar. 4, 2025

(51) Int. Cl. H01M 8/1067; B60L 50/60; C25B 9/23; C25B 9/77; C25B 11/032; C25B 13/08; H01M 8/10; H01M 8/1004; H01M 8/1032; H01M 8/1039; H01M 8/1053; H01M 16/00

(52) U.S. Cl. CPC H01M 8/1067; C25B 9/23; C25B 9/77; C25B 11/032; C25B 13/08; H01M 8/1004; H01M 8/1032; H01M 8/1039; H01M 8/1053; H01M 16/006; B60L 50/60; H01M 2008/1095; H01M 2250/20; H01M 2250/402; H01M 2300/0082; H01M 2300/0094

(57) ABSTRACT

Aspects of the disclosure include integrated membranes with engineered functional layers for fuel cell and electrolyzer applications. An exemplary proton exchange membrane (PEM) electrochemical cell includes a proton-generating electrode including an anode, a proton-consuming electrode including a cathode, and a proton exchange membrane positioned between the proton-generating electrode and the proton-consuming electrode. The proton-generating electrode, proton-consuming electrode, and proton exchange membrane collectively define a membrane-electrode-assembly (MEA). The proton exchange membrane includes an engineered functional layer. The functional layer can serve as a transit layer, a gas crossover barrier layer, or both. The PEM electrochemical cell further includes a cathode-side gas diffusion layer on the proton-consuming electrode and at least one of an anode-side gas diffusion layer and a porous transport layer on the proton-generating electrode.

### INTRODUCTION

The present disclosure relates to hydrogen fuel cells and electrolysis, and particularly to direct integrated membranes with engineered functional layers for fuel cells and electrolyzers.

Hydrogen fuel cells and related technologies have emerged as a promising clean energy solution, offering high efficiency and zero emissions for various applications ranging from transportation (e.g., personal and commercial vehicles, shipping, aircraft, etc.) to stationary power generation. In a hydrogen fuel cell, hydrogen enters through an anode, where it's split into protons and electrons. The protons pass through an electrolyte membrane, while electrons flow through an external circuit, generating electricity. At the cathode, protons, electrons, and oxygen combine to produce water. Hydrogen fuel cells are typically implemented in fuel cell stacks—assemblies of multiple individual hydrogen fuel cells connected in series to increase overall voltage and power output.

Hydrogen fuel cells require a supply of hydrogen fuel that is typically provided via one or more electrolysis cells. An electrolysis cell is a device that uses electrical energy to drive a non-spontaneous chemical reaction that splits water (H₂O) into hydrogen (H₂) and oxygen (O₂) gases. An electrolysis cell typically includes an anode, a cathode, and an electrolyte. When an electric current is applied between the anode and cathode, water molecules are split at the anode to produce oxygen gas and protons (H⁺), while at the cathode, protons combine with electrons to produce hydrogen gas.

### SUMMARY

In an exemplary embodiment a proton exchange membrane (PEM) electrochemical cell includes a proton-generating electrode including an anode, a proton-consuming electrode including a cathode, and a proton exchange membrane positioned between the proton-generating electrode and the proton-consuming electrode. The proton-generating electrode, proton-consuming electrode, and proton exchange membrane collectively define a membrane-electrode-assembly (MEA). The proton exchange membrane includes an engineered functional layer. The PEM electrochemical cell further includes a cathode-side gas diffusion layer on the proton-consuming electrode and at least one of an anode-side gas diffusion layer and a porous transport layer on the proton-generating electrode.

In some embodiments, the engineered functional layer includes a transit layer.

In some embodiments, the transit layer includes one or more of a perfluorosulfonic acid (PFSA) layer, a hydrocarbon-based layer, a blended PFSA-hydrocarbon ionomer layer, and a composite layer with one or more nano additives.

In some embodiments, the transit layer is formed on a surface of the proton exchange membrane. In some embodiments, the surface of the proton exchange membrane includes one of a surface facing the anode and a surface facing the cathode.

In some embodiments, the engineered functional layer includes one or more gas crossover barrier layers.

In some embodiments, the one or more gas crossover barrier layers include a hydrocarbon-based ionomer layer or a composite hydrocarbon ionomer layer with one or more nano additives.

In some embodiments, the proton exchange membrane further includes a bottom ionomer layer, an optional reinforcement layer, and a top ionomer layer.

In some embodiments, a first flow field is coupled to the anode-side gas diffusion layer and a second flow field is coupled to the cathode-side gas diffusion layer.

In yet another exemplary embodiment a method can include forming a proton-generating electrode including an anode, forming a proton-consuming electrode including a cathode, and forming a proton exchange membrane positioned between the proton-generating electrode and the proton-consuming electrode. The proton-generating electrode, proton-consuming electrode, and proton exchange membrane collectively define an MEA. The proton exchange membrane includes an engineered functional layer. The PEM electrochemical cell further includes a cathode-side gas diffusion layer on the proton-consuming electrode and at least one of an anode-side gas diffusion layer and a porous transport layer on the proton-generating electrode.

In some embodiments, the engineered functional layer includes a transit layer.

In some embodiments, the transit layer includes one or more of a PFSA layer, a hydrocarbon-based ionomer layer, a blended PFSA-hydrocarbon ionomer layer, and a composite layer with one or more nano additives.

In some embodiments, the transit layer is formed on a surface of the proton exchange membrane. In some embodiments, the surface of the proton exchange membrane includes one of a surface facing the anode and a surface facing the cathode.

In some embodiments, the engineered functional layer includes one or more gas crossover barrier layers. In some embodiments, the one or more gas crossover barrier layers includes a hydrocarbon-based ionomer layer or a composite hydrocarbon ionomer layer with one or more nano additives.

In some embodiments, the proton exchange membrane further includes a bottom ionomer layer, an optional reinforcement layer, and a top ionomer layer.

In another exemplary embodiment a vehicle includes an electric motor, a battery, and a PEM electrochemical cell electrically coupled to at least one of the electric motor or the battery. The PEM electrochemical cell includes a proton-generating electrode including an anode, a proton-consuming electrode including a cathode, and a proton exchange membrane positioned between the proton-generating electrode and the proton-consuming electrode. The proton-generating electrode, proton-consuming electrode, and proton exchange membrane collectively define an MEA. The proton exchange membrane includes an engineered functional layer. The PEM electrochemical cell further includes a cathode-side gas diffusion layer on the proton-consuming electrode and at least one of an anode-side gas diffusion layer and a porous transport layer on the proton-generating electrode.

In some embodiments, the engineered functional layer includes a transit layer.

In some embodiments, the transit layer includes one or more of a PFSA layer, a hydrocarbon-based ionomer layer, a blended PFSA-hydrocarbon ionomer layer, and a composite layer with one or more nano additives.

In some embodiments, the transit layer is formed on a surface of the proton exchange membrane. In some embodiments, the surface of the proton exchange membrane includes one of a surface facing the anode and a surface facing the cathode.

In some embodiments, the engineered functional layer includes one or more gas crossover barrier layers.

In some embodiments, the one or more gas crossover barrier layers include a hydrocarbon-based ionomer layer or a composite hydrocarbon ionomer layer with one or more nano additives.

In some embodiments, the proton exchange membrane further includes a bottom ionomer layer, an optional reinforcement layer, and a top ionomer layer.

In some embodiments, a first flow field is coupled to the anode-side gas diffusion layer and a second flow field is coupled to the cathode-side gas diffusion layer.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A depicts an electrolyzer in accordance with one or more embodiments;

FIG. 2B depicts a fuel cell in accordance with one or more embodiments;

FIG. 3A depicts a fuel cell stack having a membrane with one or more engineered functional layers for electrolyzer or fuel cell applications in accordance with one or more embodiments;

FIG. 3B depicts a fuel cell stack having an electrode with one or more engineered functional layers for electrolyzer or fuel cell applications in accordance with one or more embodiments;

FIG. 4 depicts a fuel cell stack having a membrane with one or more engineered functional layers for electrolyzer or fuel cell applications in accordance with one or more embodiments;

FIG. 5 depicts a fuel cell stack having a membrane with one or more engineered functional layers for electrolyzer and fuel cell applications in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses.

Understanding and optimizing proton exchange membrane (PEM) type electrochemical cells, such as hydrogen fuel cells and electrolysis cells (also referred to as electrolyzers), has become crucial for widespread adoption and commercialization of hydrogen fuel cell technologies. One of the key components in PEM type electrochemistry cells is the membrane electrode assembly (MEA). In a PEM cell, the MEA serves as the core functional unit where the primary electrochemical reactions occur, converting chemical energy into electrical energy (in fuel cells) or electrical energy into chemical energy (in electrolysis cells). More specifically, in a PEM fuel cell, the MEA facilitates the oxidation of hydrogen at the anode and the reduction of oxygen at the cathode, generating electricity along with byproduct water, while in a PEM electrolysis cell, the MEA facilitates the splitting of water into hydrogen and oxygen gases by use of electricity.

This disclosure introduces the fabrication and use of integrated membranes having engineered functional layers for fuel cell and electrolyzer applications. The functional layer(s) can be designed to enable one or more predetermined objectives, such as improved cell interlayer adhesion, lower gas crossover, improved stability, increased durability, etc. For example, in one embodiment, an objective of a functional layer is to serve as a transit layer that is more compatible and easier to bond to the adjacent membrane and electrode layers than the membrane and electrode layers are to each other. Additionally, or alternatively, a functional layer can be designed to provide gas barrier properties (e.g., lower gas crossover), thereby reducing an amount of fuel and/or reactant gases passing through the membrane.

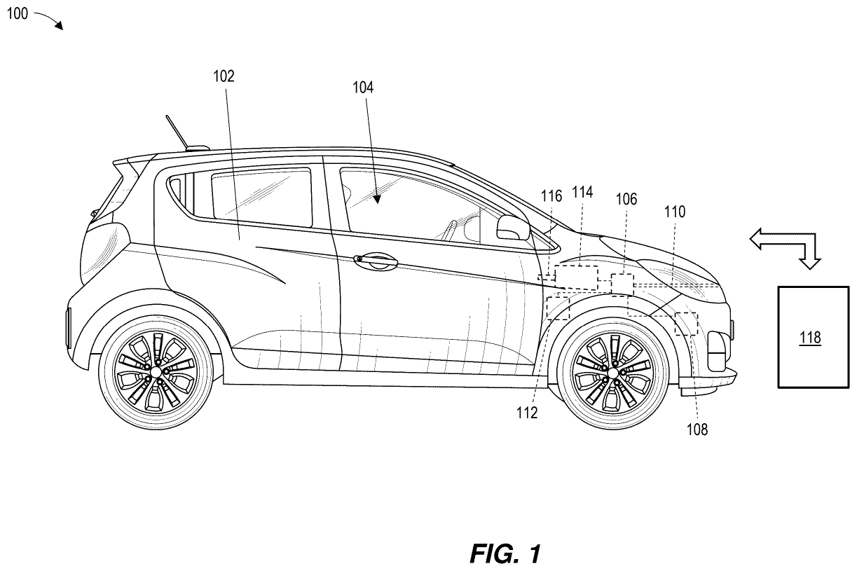

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, a fuel cell 106 (also referred to as a “fuel cell stack”), a hydrogen fuel storage tank 108, an air intake manifold 110, a battery 112, and an electric motor 114 configured for utilizing electrical energy to provide an output torque to an output component 116 (each shown by projection near the front of the vehicle 100). Fuel cell 106 receives a flow of hydrogen or other fuel gas from the hydrogen fuel storage tank 108 and receives a flow of air including oxygen gas from air intake manifold 110. The fuel cell 106 may include an air compressor device (not separately indicated) useful to pressurize the air to a desired pressure. The fuel cell 106 may provide electrical energy directly to the electric motor 114 and/or the fuel cell 106 may provide electrical energy to the battery 112 for storage and later use. The output component 116 may provide the output torque for usage, for example, to provide a motive force to the vehicle 100. In some embodiments, vehicle 100 receives hydrogen fuel from an external electrolyzer 118 (electrolysis cells) configured to produce hydrogen that can be delivered to the hydrogen fuel storage tank 108 and/or fuel cell 106.

The fuel cell 106, hydrogen fuel storage tank 108, air intake manifold 110, battery 112, electric motor 114, and electrolyzer 118 are shown for ease of illustration and discussion only. It should be understood that the configuration, location, size, arrangement, etc., of these components is not meant to be particularly limited, and all such configurations (including multi-motor configurations) are within the contemplated scope of this disclosure. Moreover, while the present disclosure is discussed primarily in the context of a fuel cell 106 and electrolyzer 118 configured for the vehicle 100, aspects described herein can be similarly incorporated within any system (vehicle, building, or otherwise) having a hydrogen fuel cell-based power and/or energy storage system(s), and all such configurations and applications are within the contemplated scope of this disclosure. In particular, the electrolyzer 118 can be configured as an entirely separate unit for standalone hydrogen and oxygen production (perhaps for serving vehicle 100 and/or other downstream applications). As will be discussed in greater detail herein, the fuel cell 106 and/or electrolyzer 118 can be modified to include a proton exchange membrane with a an engineered functional layer.

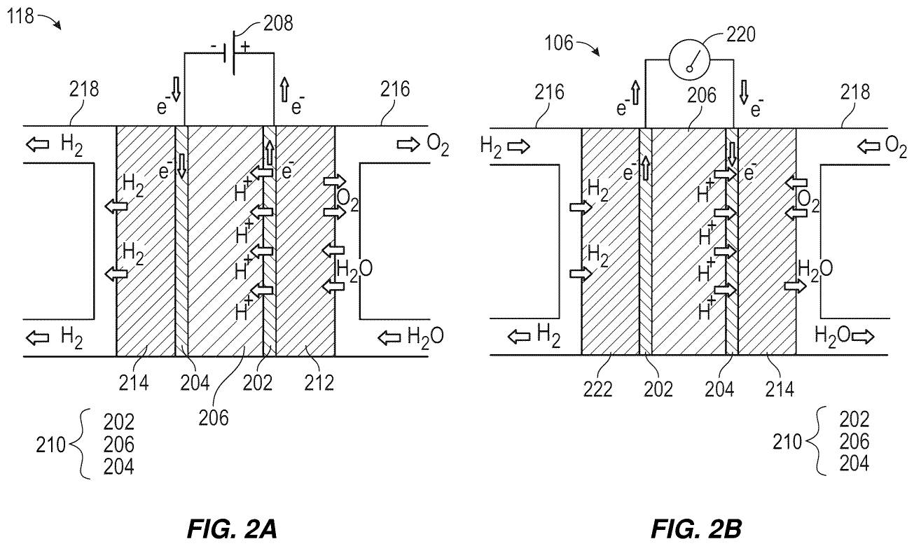

FIG. 2A depicts an electrolyzer 118 in accordance with one or more embodiments. As shown in FIG. 2A, electrolyzer 118 includes a proton-generating electrode (referred to as anode 202), a proton-consuming electrode (referred to as cathode 204), and a proton exchange membrane 206 (or simply, membrane 206) between the anode 202 and the cathode 204. The combination of the anode 202, membrane 206, and the cathode 204 together define a membrane electrode assembly (MEA) 210.

In an electrolyzer type configuration, protons (H⁺) are generated in the anode 202 and are passed through the membrane 206 to the cathode 204. More specifically, anode 202 is responsible for the oxidation of water molecules during the electrolysis process, producing oxygen gas, protons (H⁺), and electrons, while cathode 204 is responsible for the reduction of protons (H⁺) and electrons to form hydrogen gas during the electrolysis process. The protons generated at the anode 202 pass through the membrane 206 to the cathode 204. The cathode 204 facilitates the efficient combination of protons, which have passed through the membrane 206 from the anode 202, with electrons that have traveled through an external circuit (e.g., power source 208). In some embodiments, the anode 202 (the anode) and cathode 204 (the cathode) are coupled to a power source 208 which supplies a current across the anode 202 and cathode 204 so that water fed to the electrolyzer 118 can be split into hydrogen and oxygen.

In some embodiments, electrolyzer 118 includes a porous transport layer (PTL) 212 on the anode 202 and a gas diffusion layer (GDL) 214 (sometimes referred to as a gas diffusion media, or GDM) on the cathode 204.

PTL 212 facilitates a uniform distribution of reactant fluids, typically water, to the anode 202. PTL 212 also facilitates the efficient removal of by-products such as oxygen gas from electrolyzer 118. In some embodiments, PTL 212 is made of materials that offer a combination of high electrical conductivity, chemical stability, mechanical strength, and porosity, such as, for example, sintered titanium, stainless steel, and nickel-based materials such as nickel foam. In some embodiments, PTL 212 is connected via flow channels and headers (not separately indicated) to a flow field 216. In some embodiments, flow field 216 serves as the entry point(s) to the anode 202 for reactant fluid, typically water, which is necessary for the electrochemical reactions occurring within the MEA 210. Conversely, flow field 216 can include or one more outtake headers (not separately indicated) to ensure the efficient evacuation of oxygen and excess water from electrolyzer 118.

GDL 214 facilitates the collection and expulsion of hydrogen gas generated in the cathode 204. In some embodiments, GDL 214 is connected via flow channels and headers (not separately indicated) to a flow field 218. In some embodiments, flow field 218 serves as the exit point(s) for hydrogen gas formed in MEA 210. In some embodiments, GDL 214 is made of materials that offer a combination of high electrical conductivity, chemical stability, mechanical strength, and porosity, such as, for example, carbon fiber paper, carbon cloth, and other carbon-based materials.

In some embodiments, the membrane 206 is a solid polymer electrolyte that conducts protons (H⁺) while acting as an insulator for electrons, ensuring that the protons generated at the anode 202 can pass through to the cathode 204 while preventing the mixing of product gases. In some embodiments, the anode 202 and/or cathode 204 are catalyst layers attached (laminated to or directly coated) on both sides of the membrane 206. These catalyst layers facilitate the electrochemical reactions: at the anode 202, water molecules are oxidized to produce oxygen gas, protons, and electrons, while at the cathode 204, protons and electrons combine to form hydrogen gas. In some embodiments, the anode 202 contains finely dispersed catalyst particles such as iridium (IrOx) and/or titanium oxide particles, while the cathode 204 contains finely dispersed catalyst particles such as platinum (Pt), supported by carbon particles. The catalyst layers can be coated on the membrane 206, coated on the PTL 212, coated on the GDL 214, and/or decal transferred to any or all of membrane 206, PTL 212, and GDL 214. The electrolyzer cell 118 can be combined with other electrolyzer cells to define a electrolyzer stack (not separately indicated) having any number of cells, as desired.

FIG. 2B depicts a fuel cell 106 in accordance with one or more embodiments. Fuel cell 106 is configured similarly to the electrolyzer 118 discussed with respect to FIG. 2A, except that, in a fuel cell type configuration, the anode 202 and cathode 204 are coupled to a load 220 (e.g., an electric motor, etc., such as the electric motor 114 of FIG. 1) which is powered via a current generated by the fuel cell 106 and the PTL 212 is replaced by a second GDL 222. Current is generated within fuel cell 106 due to the reaction of hydrogen gas with oxygen, producing water. Specifically, hydrogen is oxidized at the anode 202, conducting electrons through the load 222, and conducting protons through the membrane 206. During this process oxygen is reduced at the cathode 204 to form water.

As shown in FIG. 2B, fuel cell 106 includes an anode 202, a cathode 204, and a membrane 206 between the anode 202 and the cathode 204. The combination of anode 202, membrane 206, and cathode 204 together define an MEA 210. In a fuel cell type configuration, these components work together to convert chemical energy from hydrogen and oxygen into electrical energy through electrochemical reactions, as opposed to the electrolyzer configuration in FIG. 2A, which uses electrical energy to split water into hydrogen and oxygen. In the fuel cell configuration, the anode 202 is where hydrogen gas (H₂) is supplied and oxidized. The protons generated at the anode 202 pass through the membrane 206 to the cathode 204, while the electrons are conducted away from the anode 202, creating an electric current that can be used to power the load 220. In this configuration, the cathode 204 is where oxygen gas (O₂) is supplied and reduced. At the cathode 204, the protons (H⁺) that have passed through the membrane 206 combine with the electrons (e⁻) that have traveled through the load 220 and with oxygen molecules to form water (H₂O). GDL 214 and flow field 218 facilitate the transport of oxygen (typically from air) into MEA 210 and the removal of water from the fuel cell 106. Conversely, GDL 222 and flow field 216 facilitate the transport of hydrogen gas into MEA 210 and the removal of excess hydrogen gas from the fuel cell 106. The fuel cell 106 can be combined with other fuel cells to define a fuel cell stack (not separately indicated) having any number of cells, as desired.

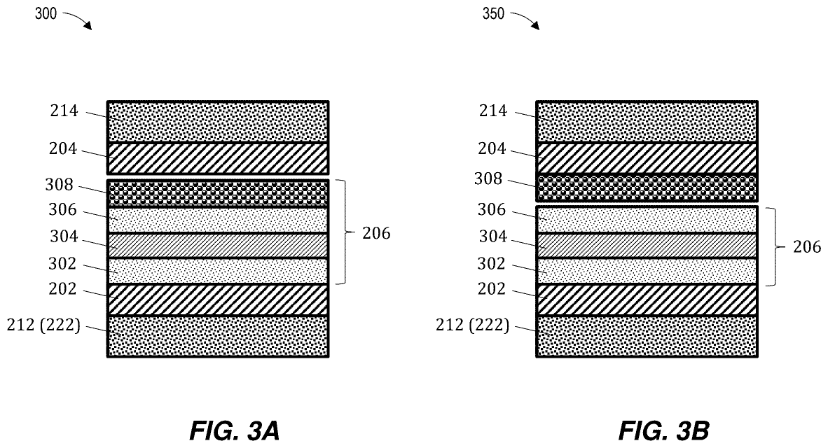

FIG. 3A depicts a fuel cell or electrolyzer cell 300 (referred to hereinafter as fuel cell 300 for simplicity) having a membrane 206 with an engineered functional layer for electrolyzer (e.g., electrolyzer 118 of FIG. 2A) and fuel cell (e.g., fuel cell 106 of FIG. 2B) applications in accordance with one or more embodiments. As shown in FIG. 3A, the fuel cell 300 includes PTL 212 (or second GDL 222), anode 202, membrane 206, cathode 204, and GDL 214, with the selection of PTL 212 and second GDL 222 depending on whether the fuel cell 300 is configured as a fuel cell 106 or as an electrolyzer 118 (refer to FIGS. 2A and 2B, respectively). As further shown in FIG. 3A, in some embodiments, membrane 206 is a multilayer structure that includes a bottom ionomer layer 302, an optional reinforcement layer 304, a top ionomer layer 306, and an integrated engineered functional layer configured as a transit layer 308. In other words, FIG. 3A depicts a functional layer-membrane integration. It should be understood that the configuration shown for the membrane 206 is merely illustrative. Other configurations are possible and within the contemplated scope of this disclosure. For example, in some embodiments, membrane 206 is a bulk-type, or single layer material (not separately shown). Moreover, the optional reinforcement layer 304 can be present in some membrane configurations, but absent in others.

In some embodiments, membrane 206 is a direct integrated membrane. As used herein, a direct integrated membrane is a membrane that is fabricated and integrated directly with the electrode layers (e.g., anode 202 and/or cathode 204) during the manufacturing process, rather than being produced separately and then assembled. Direct membrane integration can offer a more seamless and efficient fabrication process and, in some cases, can enhance the overall performance and durability of the fuel cell 300. In particular, in some embodiments, the various layers of the membrane 206, such as the bottom ionomer layer 302, reinforcement layer 304, top ionomer layer 306, and/or transit layer 308 can be applied directly onto an electrode substrate (e.g., the anode 202 and/or cathode 204). Direct membrane integration can involve techniques such as casting, coating, spraying, and/or sputtering, allowing for precise control over the thickness and uniformity of each layer. It should be understood that, while direct integration of the membrane is illustrated, other methods of introducing a functional barrier layer are possible and contemplated within the scope of this disclosure. For example, the engineered functional layer could be applied on a free-standing membrane roll or transferred on to the surface of the free-standing membrane roll. Alternately, the membrane could be applied on the engineered functional layer coated on any substrate.

In some embodiments, bottom ionomer layer 302 and/or top ionomer layer 306 are made of, one or more ion-conductive polymer materials, or blends thereof, such as, for example, perfluorosulfonic acid (PFSA) ionomers or sulfonated poly(ether ether ketone) (SPEEK) ionomers. Advantageously, bottom ionomer layer 302 and/or top ionomer layer 306 aid in providing proton conductivity through membrane 206 and/or serve as a structural foundation layer of membrane 206. The bottom ionomer layer 302 and/or top ionomer layer 306 can be formed by casting or coating an ionomer solution onto an underlying substrate (e.g., the anode 202 or cathode 204), followed by drying and curing to achieve a desired thickness and uniformity.

In some embodiments, reinforcement layer 304 is introduced and/or included between the bottom ionomer layer 302 and top ionomer layer 306. The reinforcement layer 304 is made from materials selected to provide mechanical stability and structural support to the membrane 206, as well as proton conduction. In some embodiments, reinforcement layer 304 is a porous structure that allows for the integration of ionomer materials from the bottom ionomer layer 302 and/or top ionomer layer 306. Example materials include, for example expanded polytetrafluoroethylene (ePTFE), woven or non-woven fabrics made from PEEK, polysulfone (PSU), polyvinylidene fluoride (PVDF), polyolefin fibers, and blends thereof. In some embodiments, reinforcement layer 304 is fabricated by weaving or bonding fibers over the bottom ionomer layer 302. In some embodiments, reinforcement layer 304 defines a porous matrix onto which the top ionomer layer 306 is formed. In some embodiments, reinforcement layer 304 can undergo one or more surface treatments, such as sulfonation, to enhance compatibility with the bottom ionomer layer 302 and top ionomer layer 306. While not meant to be particularly limited, in some embodiments, reinforcement layer 304 can be formed (e.g., fibers can be deposited) such that a final thickness of the reinforcement layer 304 is between 10 and 80 percent, or between 30 and 70 percent, for example 60 percent, of a total thickness of membrane 206.

In some embodiments, transit layer 308 is made of materials selected to improve adhesion between the membrane 206 and an electrode layer(s) (e.g., anode 202 and/or cathode 204). Example materials for improving adhesion at the interface between these layers include PFSA layers, hydrocarbon-based ionomer layers, a blend of PFSA and hydrocarbon layers, and/or composite materials with nano additives, and combinations thereof. As used herein, a nano additive refers to nanoscale materials (e.g., sub-micron materials) that can be incorporated into an ionomer or composite hydrocarbon ionomer layer to enhance its properties. Nano additives can be of the form of nanoparticles, nanofibers, or other nanostructures, and the addition of nano additives can be leveraged to improve or modify the mechanical, chemical, adhesion, and/or functional characteristics of the membrane 206. Example materials include metal oxide nanoparticles (e.g., zirconium dioxide, cerium zirconate, cerium oxide, manganese dioxide, etc.), carbon-based nanomaterials (e.g., carbon nanotubes, graphene oxide, carbon block, etc.), nanofibers (e.g., electrospun polymer nanofibers such as polyvinylidene fluoride or polyacrylonitrile fibers), and inorganic nanoparticles (e.g., silica, alumina, titania, etc.).

In some embodiments, transit layer 308 can be formed on the top ionomer layer 306 using techniques such as wet coating, spraying, and/or sputtering. In some embodiments, transit layer 308 is formed as a single layer structure. Alternatively, in some embodiments, transit layer 308 is formed over multiple successive steps to achieve a targeted thickness and associated properties, allowing the transit layer 308 to be customized to ensure compatibility with the selected membrane and electrode materials. In some embodiments, transit layer 308 is directly, and optionally simultaneously, applied to the membrane 206 together with the cathode 204 (or anode 202 depending on electrode manufacturing order). In some embodiments, transit layer 308 is formed using a direct deposition technique. In this scenario, for example, after the deposition of the bottom ionomer layer 302, reinforcement layer 304, and top ionomer layer 306, a PFSA or PFSA-HC-ionomer blended transit layer 308 can be applied directly on top of the top ionomer layer 306. Advantageously, the presence of the transit layer 308 within the fuel cell 300 relaxes the material constraints on the membrane 206 materials, especially the top ionomer layer 306. In addition, by improving the membrane-electrode interface connection between membrane 206 and the anode 202/cathode 204, a fuel cell 300 (and corresponding MEA 210, refer to FIGS. 2A and 2B) can be manufactured to provide relatively higher fuel efficiency, performance, and durability than fuel cell stacks manufactured without transit layer 308.

While not separately indicated, the manufacturing process for membrane 206 can include additional fabrication steps, such as the application of one or more heat treatments, plasma treatments, etc. In some embodiments, the manufacturing process for membrane 206 can include the formation and/or incorporation of one or more gas recombination catalyst additives such as, for example, platinum, platinum-on-carbon (Pt/C), etc. Alternatively, or in addition, membrane 206 can include one or more chemical mitigation additives, such as, for example, cerium, manganese, cobalt, chemical compounds thereof, and blends thereof.

FIG. 3B depicts a fuel cell or electrolyzer cell 350 (referred to hereinafter as fuel cell 350 for simplicity) having an electrode with an engineered functional layer for electrolyzer (e.g., electrolyzer 118 of FIG. 2A) and fuel cell (e.g., fuel cell 106 of FIG. 2B) applications in accordance with one or more embodiments. As shown in FIG. 3B, the fuel cell 350 includes PTL 212 (or second GDL 222), anode 202, membrane 206, cathode 204, and GDL 214, with the selection of PTL 212 and second GDL 222 depending on whether the fuel cell 300 is configured as a fuel cell 106 or as an electrolyzer 118 (refer to FIGS. 2A and 2B, respectively). As further shown in FIG. 3B, in some embodiments, membrane 206 is a multilayer structure that includes a bottom ionomer layer 302, an optional reinforcement layer 304, and a top ionomer layer 306. It should be understood that the configuration shown for the membrane 206 is merely illustrative. Other configurations are possible and within the contemplated scope of this disclosure. For example, in some embodiments, membrane 206 is a bulk-type, or single layer material (not separately shown). Moreover, the optional reinforcement layer 304 can be present in some membrane configurations but absent in others.

As further shown in FIG. 3B, the fuel cell 350 includes an engineered functional layer configured as a transit layer 308. The fuel cell 350 can be formed of similar materials and in a similar manner as previously described with respect to the fuel cell 300 (refer to FIG. 3A), except that, in the embodiment shown in FIG. 3B, the engineered functional layer (configured as a transit layer 308) is integrated with the cathode 204. In other words, FIG. 3B depicts a functional layer-electrode integration. The transit layer 308 is shown integrated with the cathode 204 for illustrative purposes. In addition, or alternatively, the functional layer-electrode integration can include the anode 202 (that is, transit layer 308 can be integrated with anode 202).

Observe that, while FIG. 3A depicts a functional layer-membrane integration and FIG. 3B shows a functional layer-electrode integration, these techniques need not be separated. In some embodiments, these processes can be combined to provide a fuel cell (or electrolyzer cell) that includes both a functional layer-electrode integration and a functional layer-membrane integration (not separately indicated).

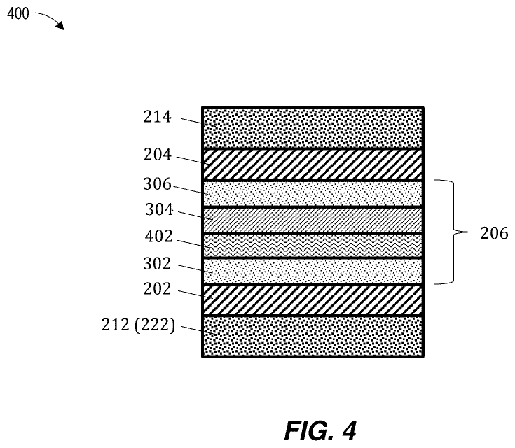

FIG. 4 depicts a fuel cell or electrolyzer cell 400 (referred to hereinafter as fuel cell 400 for simplicity) having a membrane 206 with an engineered functional layer for electrolyzer (e.g., electrolyzer 118 of FIG. 2A) and fuel cell (e.g., fuel cell 106 of FIG. 2B) applications in accordance with one or more embodiments. As shown in FIG. 4, the fuel cell 400 includes PTL 212 (or second GDL 222), anode 202, membrane 206, cathode 204, and GDL 214, with the selection of PTL 212 and second GDL 222 depending on whether the fuel cell 400 is configured as a fuel cell 106 or as an electrolyzer 118 (refer to FIGS. 2A and 2B, respectively). The fuel cell 400 can be formed of similar materials and in a similar manner as previously described with respect to the fuel cell 300 (refer to FIGS. 3A and 3B), except that, in the embodiment shown in FIG. 4, the transit layer 308 is replaced with a gas crossover barrier layer 402.

More specifically, membrane 206 is a multilayer structure that includes a bottom ionomer layer 302, a reinforcement layer 304, a top ionomer layer 306, and an engineered functional layer configured as a gas crossover barrier layer 402. Notably, in contrast to the transit layer 308, which must be placed at the membrane-electrode interface of the fuel cell 300 (again, refer to FIGS. 3A and 3B), gas crossover barrier layer 402 can be placed at any position within the membrane 206 (as shown, the gas crossover barrier layer 402 is positioned between the bottom ionomer layer 302 and reinforcement layer 304). In other embodiments, gas crossover barrier layer 402 can be placed directly on the anode 202 (or cathode 204), between the reinforcement layer 304 and top ionomer layer 306, or over the top ionomer layer 306, as desired.

Example materials for the gas crossover barrier layer 402 include, for example, hydrocarbon-based ionomer layers and composite hydrocarbon ionomer layers with nano additives. Nano additives can include, for example, metal oxides (e.g., ZrO₂, CeZrO₄, CeO₂, MnO₂, etc.), carbon, graphene oxide, and combinations thereof. Gas crossover barrier layer 402 can be formed and/or deposited using techniques such as wet coating, spraying, and/or sputtering. Gas crossover barrier layer 402 can be formed as a single layer or multilayer structure as desired. Gas crossover barrier layer 402 can be formed or deposited in various formats, such as, for example, as pallets, flakes, fibers, or combinations thereof, to enhance mechanical, chemical, or other desired properties of the membrane 206 and/or fuel cell 400. Advantageously, gas crossover barrier layer 402 can impart chemical durability mitigation to the membrane 206, especially in embodiments which include metal oxides or platinum as additives.

In some embodiments, gas crossover barrier layer 402 is directly, and optionally simultaneously, applied to the membrane 206 together with the cathode 204 (or anode 202 depending on electrode manufacturing order). In some embodiments, gas crossover barrier layer 402 is formed at any desired position within the membrane 206 using direct deposition techniques. For example, after the deposition of the bottom ionomer layer 302, reinforcement layer 304, and top ionomer layer 306, composite hydrocarbon ionomer layers with nano additives can be applied directly on top of the top ionomer layer 306. Additionally, or alternatively, composite hydrocarbon ionomer layers with nano additives can be applied directly to the anode 202, the cathode 204, the bottom ionomer layer 302, and/or the reinforcement layer 304. Advantageously, the gas crossover barrier layer 402 reduces reactant and fuel gas crossover through the membrane 206, improving the efficiency of the fuel cell 400 as compared to fuel cell stacks manufactured without gas crossover barrier layer 402. While shown having a single gas crossover barrier layer 402, this is for simplicity and ease of illustration only. In some embodiments, fuel cell 400 (or electrolyzer cell) can include two or more gas crossover barrier layers 402. The gas crossover barrier layers 402 can be placed in separate locations throughout the fuel cell 400 (or electrolyzer cell), as desired.

While not separately indicated, the manufacturing process for membrane 206 can include additional fabrication steps, such as the application of one or more heat treatments, plasma treatments, etc. In some embodiments, the manufacturing process for membrane 206 can include the formation and/or incorporation of one or more gas recombination catalyst additives such as, for example, platinum, platinum-on-carbon (Pt/C), etc. Alternatively, or in addition, membrane 206 can include one or more chemical mitigation additives, such as, for example, cerium, manganese, cobalt, chemical compounds thereof, and blends thereof.

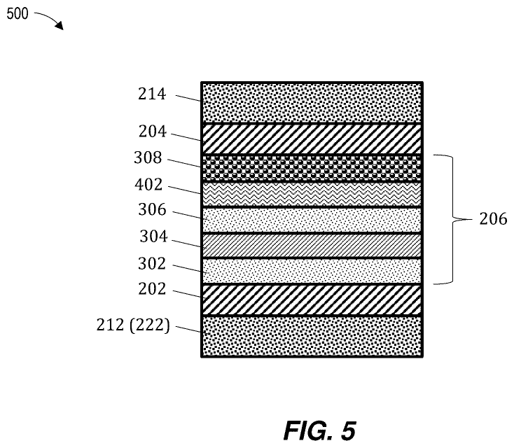

FIG. 5 depicts a fuel cell or electrolyzer cell 500 (referred to hereinafter as fuel cell 500 for simplicity) having a membrane 206 with an engineered functional layer for electrolyzer (e.g., electrolyzer 118 of FIG. 2A) and fuel cell (e.g., fuel cell 106 of FIG. 2B) applications in accordance with one or more embodiments. As shown in FIG. 5, the fuel cell 500 includes PTL 212 (or second GDL 222), anode 202, membrane 206, cathode 204, and GDL 214, with the selection of PTL 212 and second GDL 222 depending on whether the fuel cell 500 is configured as a fuel cell 106 or as an electrolyzer 118 (refer to FIGS. 2A and 2B, respectively). The fuel cell 500 can be formed of similar materials and in a similar manner as previously described with respect to the fuel cell 300 (refer to FIGS. 3A and 3B) and the fuel cell 400 (refer to FIG. 4), except that, in the embodiment shown in FIG. 5, both the transit layer 308 and the gas crossover barrier layer 402 are present. While shown as separate layers, this is for simplicity. In some embodiments, the transit layer 308 and the gas crossover barrier layer 402 are the same layer. In other words, a single layer can serve as both the transit layer 308 and the gas crossover barrier layer 402 depending on material selection.

In some embodiments, the transit layer 308 is positioned as a topmost layer of the membrane 206. In particular, the transit layer 308 is positioned at the interface to the cathode 204 (or anode 202 in cathode-first manufacturing schemes). Conversely, the gas crossover barrier layer 402 can be placed at any position within membrane 206, as discussed previously with respect to FIG. 4. For example, as shown in FIG. 5, the transit layer 308 can be positioned directly on the gas crossover barrier layer 402, which can be positioned directly on the top ionomer layer 306. Alternatively, the gas crossover barrier layer 402 can drop down to any position within membrane 206.

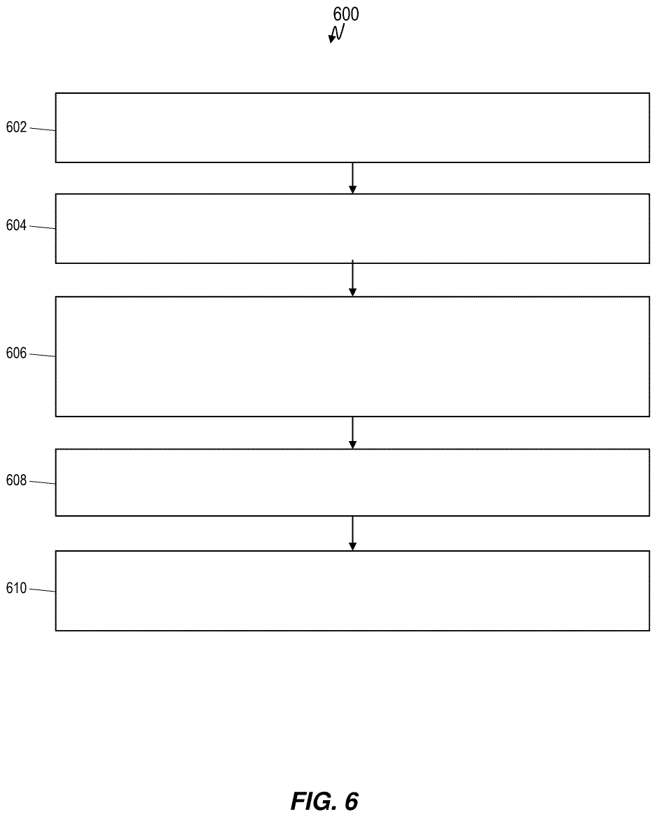

Referring now to FIG. 6, a flowchart 600 for forming integrated membranes with engineered functional layers for fuel cells and electrolyzers is generally shown according to an embodiment. The flowchart 600 is described in reference to FIGS. 1-5 and may include additional steps not depicted in FIG. 6. Although depicted in a particular order, the blocks depicted in FIG. 6 can be rearranged, subdivided, and/or combined.

At block 602, the method includes forming a cathode-side gas diffusion layer.

At block 604, the method includes forming at least one of an anode-side gas diffusion layer and a porous transport layer.

At block 606, the method includes forming a proton-consuming electrode including a cathode on a surface of the cathode-side gas diffusion layer.

At block 608, the method includes forming a proton-generating electrode including an anode on a surface of at least one of the anode-side gas diffusion layer and the porous transport layer.

At block 610, the method includes forming a proton exchange membrane positioned between the proton-generating electrode and the proton-consuming electrode. The proton exchange membrane includes an engineered functional layer.

In some embodiments, the engineered functional layer is a transit layer (refer to FIGS. 3A and 3B). In some embodiments, the transit layer includes one or more of a perfluorosulfonic acid (PFSA) layer, a hydrocarbon layer, a blended PFSA-hydrocarbon layer, and a composite layer with one or more nano additives. In some embodiments, the transit layer is formed on a surface of the proton exchange membrane using a direct deposition technique. In some embodiments, the surface of the proton exchange membrane includes one of a surface facing the anode and a surface facing the cathode.

In some embodiments, the transit layer is formed on a surface of the proton exchange membrane. In some embodiments, the surface of the proton exchange membrane includes one of a surface facing the anode and a surface facing the cathode.

In some embodiments, the engineered functional layer is a gas crossover barrier layer (refer to FIG. 4). In some embodiments, the gas crossover barrier layer includes a hydrocarbon-based ionomer layer or a composite hydrocarbon ionomer layer with one or more nano additives.

In some embodiments, the proton exchange membrane further includes a bottom ionomer layer, a reinforcement layer, and a top ionomer layer.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A proton exchange membrane (PEM) electrochemical cell comprising:
a proton-generating electrode comprising an anode;
a proton-consuming electrode comprising a cathode;
a proton exchange membrane positioned between the proton-generating electrode and the proton-consuming electrode, the proton exchange membrane comprising an engineered functional layer;
a cathode-side gas diffusion layer on the proton-consuming electrode; and
at least one of an anode-side gas diffusion layer and a porous transport layer on the proton-generating electrode.

2. The PEM electrochemical cell of claim 1, wherein the engineered functional layer comprises a transit layer.

3. The PEM electrochemical cell of claim 2, wherein the transit layer comprises one or more of a perfluorosulfonic acid (PFSA) layer, a hydrocarbon-based ionomer layer, a blended PFSA-hydrocarbon ionomer layer, and a composite layer with one or more nano additives.

4. The PEM electrochemical cell of claim 3, wherein the transit layer is formed on a surface of the proton exchange membrane using a direct deposition technique, wherein the surface of the proton exchange membrane comprises one of a surface facing the anode and a surface facing the cathode.

5. The PEM electrochemical cell of claim 1, wherein the engineered functional layer comprises one or more gas crossover barrier layers.

6. The PEM electrochemical cell of claim 5, wherein a gas crossover barrier layer comprises a hydrocarbon-based ionomer layer or a composite hydrocarbon ionomer layer with one or more nano additives.

7. The PEM electrochemical cell of claim 1, wherein the proton exchange membrane further comprises a bottom ionomer layer, a reinforcement layer, and a top ionomer layer.

8. A method comprising:
forming a cathode-side gas diffusion layer;
forming at least one of an anode-side gas diffusion layer and a porous transport layer;
forming a proton-consuming electrode comprising a cathode on a surface of the cathode-side gas diffusion layer;
forming a proton-generating electrode comprising an anode on a surface of at least one of the anode-side gas diffusion layer and the porous transport layer; and
forming a proton exchange membrane positioned between the proton-generating electrode and the proton-consuming electrode, the proton exchange membrane comprising an engineered functional layer.

9. The method of claim 8, wherein the engineered functional layer comprises a transit layer.

10. The method of claim 9, wherein the transit layer comprises one or more of a perfluorosulfonic acid (PFSA) layer, a hydrocarbon-based ionomer layer, a blended PFSA-hydrocarbon layer, and a composite layer with one or more nano additives.

11. The method of claim 10, wherein the transit layer is formed on a surface of the proton exchange membrane, wherein the surface of the proton exchange membrane comprises one of a surface facing the anode and a surface facing the cathode.

12. The method of claim 8, wherein the engineered functional layer comprises a gas crossover barrier layer, wherein the gas crossover barrier layer comprises a hydrocarbon-based ionomer layer or a composite hydrocarbon ionomer layer with one or more nano additives.

13. The method of claim 12, wherein the proton exchange membrane further comprises a bottom ionomer layer, a reinforcement layer, and a top ionomer layer.

14. A vehicle comprising:
an electric motor;
a battery electrically coupled to the electric motor; and
a proton exchange membrane electrochemical cell electrically coupled to at least one of the electric motor or the battery, the proton exchange membrane electrochemical cell comprising:
a proton-generating electrode comprising an anode;
a proton-consuming electrode comprising a cathode;
a proton exchange membrane positioned between the proton-generating electrode and the proton-consuming electrode, the proton exchange membrane comprising an engineered functional layer;
a cathode-side gas diffusion layer on a surface of the proton-consuming electrode; and
at least one of an anode-side gas diffusion layer and a porous transport layer on a surface of the proton-generating electrode;
wherein the proton-generating electrode, the proton-consuming electrode, and the proton exchange membrane collectively define a membrane-electrode-assembly (MEA).

15. The vehicle of claim 14, wherein the engineered functional layer comprises a transit layer.

16. The vehicle of claim 15, wherein the transit layer comprises one or more of a perfluorosulfonic acid (PFSA) layer, a hydrocarbon-based ionomer layer, a blended PFSA-hydrocarbon ionomer layer, and a composite layer with one or more nano additives.

17. The vehicle of claim 16, wherein the transit layer is formed on a surface of the proton exchange membrane, wherein the surface of the proton exchange membrane comprises one of a surface facing the anode and a surface facing the cathode.

18. The vehicle of claim 14, wherein the engineered functional layer comprises one or more gas crossover barrier layers.

19. The vehicle of claim 18, wherein the proton exchange membrane further comprises a bottom ionomer layer, a reinforcement layer, and a top ionomer layer.

20. The vehicle of claim 18, wherein a gas crossover barrier layer comprises a hydrocarbon-based ionomer layer or a composite hydrocarbon ionomer layer with one or more nano additives.
